(19) United States
(12) Patent Application Publication
(10) Pub. No.: US 2007/0056649 A1
(43) Pub. Date: Mar. 15, 2007

(54) Pressure container with replaceable bellows

(76) Inventor: Hsu Pin Chang, Da-an Township (TW)

Correspondence Address: PRO-TECHTOR INTERNATIONAL SERVICES, 20775 NORADA CT., SARATOGA, CA, 95070, US

(21) Appl. No.: 11/233,990

(22) Filed: Sep. 9, 2005

(51) Int. Cl. F16L 55/04

(52) U.S. Cl. 138/30

(57) ABSTRACT

A pressure container comprises a container comprising an upper first space, a lower second space, and a removable cover; an air pipe assembly disposed externally of the container and comprising an air input and air pressure regulator; and a bellows releasably secured to the cover and disposed in the first space. Air is adapted to flow from the second space to the bellows through the air pipe assembly for expanding the bellows when air in the second space has a pressure larger than that of air in the first space. Liquid is adapted to flow from the liquid intake into the first space to compress the bellows for expelling air into the second space via the air pipe assembly. The bellows is pressed down by air flowing from the second space to the bellows through the air pipe assembly for flowing water out of the first space.

### BACKGROUND OF THE INVENTION

1. Field of Invention

The present invention relates to pressure containers mounted in a water supplying system, and more particularly to such a pressure container having a replaceable bellows with improved characteristics.

2. Related Art

A conventional pressure container is shown in FIGS. 1 and 2 and comprises a container 80 having an internal space 81 for storing air 91 and/or liquid (e.g., water) 92, an annular frame 82 mounted on an inner surface of the space 81, the frame 81 having a bellows 821 mounted on the inner surface of the space 81 and fastened by the frame 82, an air valve 83 through a lower portion of the space 81 for communicating air between the space 81 and the external, and a liquid channel 84 through an upper portion of the space 81 for communicating liquid between the space 81 and the external. However, the bellows 821 cannot be replaced if it is damaged. Thus, the need for improvement still exists.

### SUMMARY OF THE INVENTION

It is therefore an object of the present invention to provide a pressure container mounted in a water supplying system, comprising a container comprising a top chamber, an upper first space in fluid communication with the chamber, a lower second space separated from the first space and including a first port, a liquid intake through the first space, and a cover releasably secured to the chamber and including a second port in fluid communication with the chamber; an air pipe assembly disposed externally of the container and comprising an air duct having one end connected to the second port and the other end connected to the first port, and an air input and air pressure regulator; and a bellows releasably secured to the cover and disposed in the first space; wherein in a first operation air is adapted to flow from the second space to the bellows through the first port, the air duct, the second port, and the chamber for expanding the bellows when air in the second space has a pressure larger than that of air in the first space; in a second operation liquid is adapted to flow from the liquid intake into the first space to compress the bellows for expelling air into the second space via the chamber, the second port, the air duct, and the first port; and in a third operation the bellows is pressed down by air flowing from the second space to the bellows through the first port, the air duct, the second port, and the chamber for flowing water out of the first space via the liquid intake.

In one aspect of the present invention, there is further provided a filter mounted between the chamber and the bellows.

The above and other objects, features and advantages of the present invention will become apparent from the following detailed description taken with the accompanying drawings.

### BRIEF DESCRIPTION OF THE DRAWINGS

FIG. 1 is a sectional view of a conventional pressure container where liquid is flowing thereinto via a liquid channel and air is being expelled via an air valve;

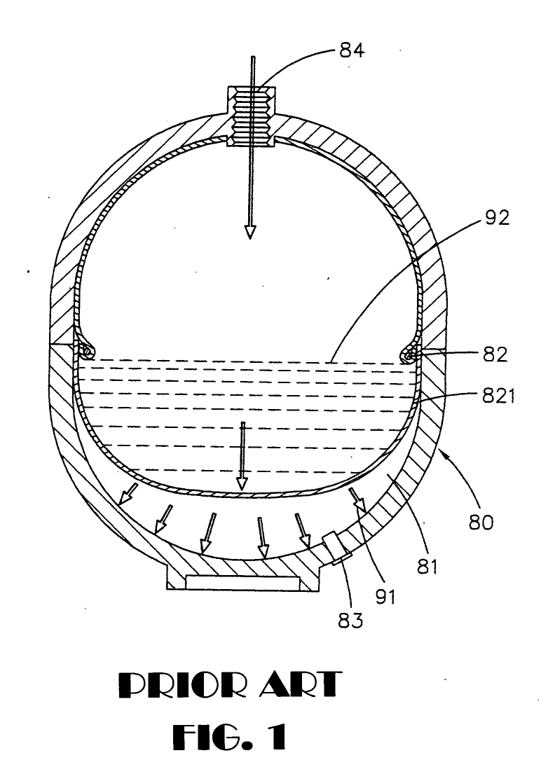

FIG. 2 is a view similar to FIG. 1 where air is flowing into the container via the air valve and liquid is exiting via the liquid channel;

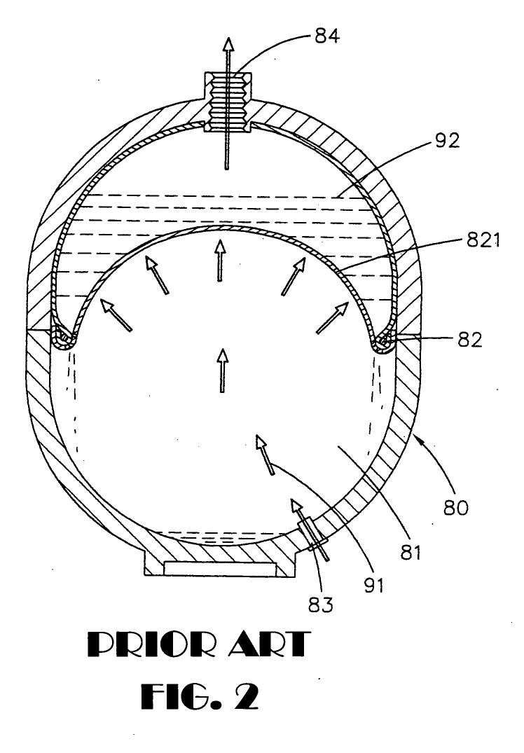

FIG. 3 is a sectional view of a preferred embodiment of pressure container according to the invention where air is flowing from a second space to a first space;

FIG. 4 is a view similar to FIG. 3 where liquid (e.g., filtered water) is flowing into the first space to expel air in a bellows into the second space via an air pipe assembly;

FIG. 5 is a view similar to FIG. 3 where liquid is flowing out of the first space and the bellows is expanding accordingly; and

FIG. 6 is a view similar to FIG. 3 where regulated amount of air is flowing from the second space to the first space.

### DETAILED DESCRIPTION OF THE INVENTION

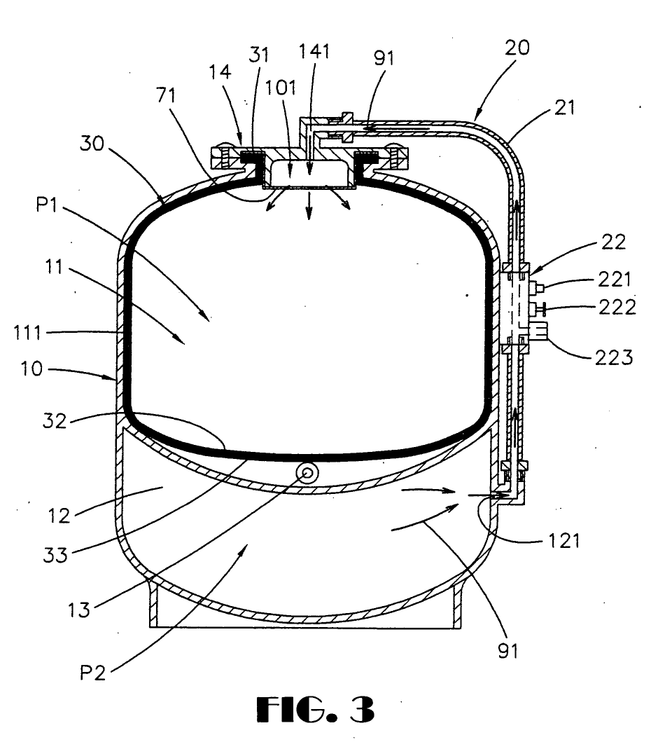

Referring to FIG. 3, a pressure container in accordance with a preferred embodiment of the invention comprises a container 10, an air pipe assembly 20, and a bellows 30. Each component is discussed in detailed below.

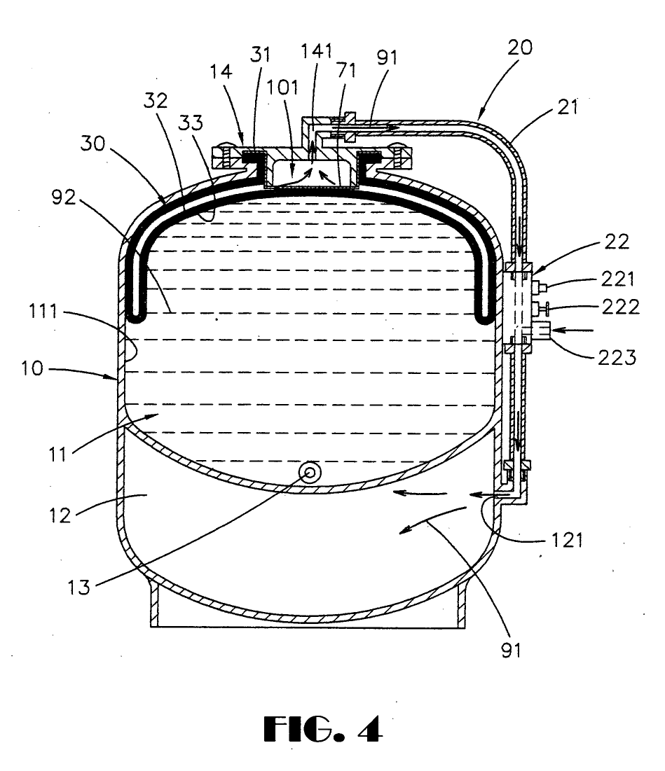

The container 10 comprises a top chamber 101, an upper first space 11 in fluid communication with the chamber 101 and including an inner surface 111; a lower second space 12 separated from the first space 11 and including a first port 121 through its inner surface; a liquid intake 13 through the inner surface 111 of the first space 11 such that liquid (e.g., water filtered by reverse osmosis as shown in FIG. 4) 92 may enter the first space 11 through the liquid intake 13 or leave the first space 11 through same; and a cover 14 threadedly secured to the chamber 101 for maintaining an airtight-ness of the container 10 and including a second port 141 in fluid communication with the chamber 101.

The air pipe assembly 20 disposed externally of the container 10 and comprises an air duct 21 having one end connected to the second port 141 which is in fluid communication with the first space 11, and the other end connected to the first port 121 which is in fluid communication with the second space 12; and a pressure regulator 22 comprising a switch 221 for opening or closing the air duct 21, a pressure regulation handle 222 for regulating internal pressure of the container 10, and an air valve 223 for permitting gas (e.g., air) 91 to enter the air duct 21 or not.

The bellows 30 comprises a top mounting member 31 releasably secured between the chamber 101 and the cover 14 such that opening the cover 14 may remove the bellows 30 for cleaning, replacement, etc. Through the chamber 101, a first surface 32 facing the chamber 101 and the second port 141, and a second surface 33 having most portions in contact with the inner surface 111 and being in fluid communication with the liquid intake 13.

Referring to FIG. 3 again, the container of the invention operates in cooperation with a reverse osmosis based water supplying system. As shown, only air 91 having a pressure P2 is flowing from the second space 12 to the bellows 30 through the first port 121, the air duct 21, the second port 141, and the chamber 101. Thus, air pressure P1 lower than pressure P2 is exerted on the first surface 32 to push same. As such, the second surface 33 moves toward the inner surface 111 and contacts same.

Referring to FIG. 4, liquid (e.g., water filtered by reverse osmosis) 92 having a pressure larger than both pressure P1 and pressure P2 is flowing from the liquid intake 13 into the first space 11 to push the second surface 33 and thus the first surface 32 upward. As such, air 91 in the bellows 30 is expelled into the second space 12 via the chamber 101, the second port 141, the air duct 21, and the first port 121.

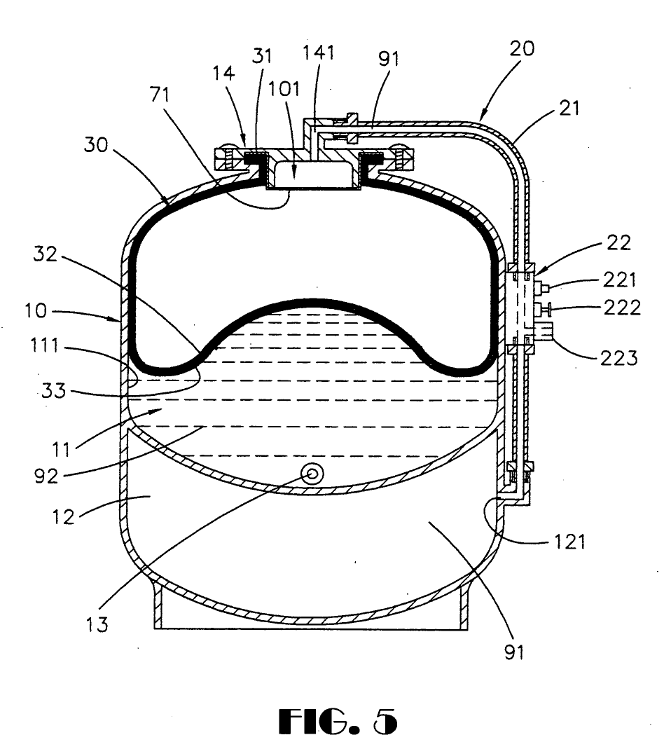

Referring to FIG. 5, the first surface 32 and thus the second surface 33 are pressed down by input air 91 when air 91 is flowing from the second space 12 to the bellows 30 through the first port 121, the air duct 21, the second port 141, and the chamber 101. As a result, water (e.g., tap water) 92 is flowing out of the first space 11 via the liquid intake 13.

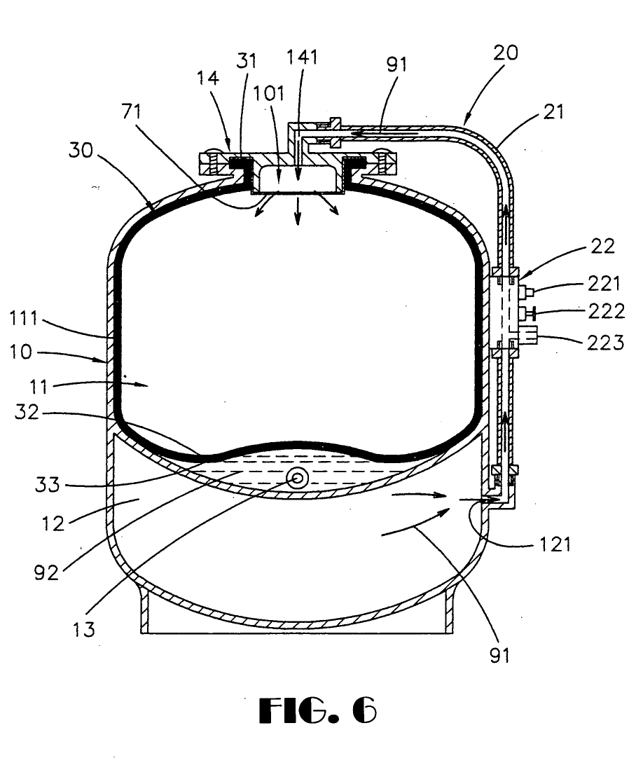

Referring to FIG. 6, a user may manipulate the pressure regulation handle 222 to adjust internal pressure of the container 10 for causing regulated amount of air 91 to flow from the second space 12 to the first space 11.

Moreover, a filter 71 in the form of net is mounted between the chamber 101 and the bellows 30. The provision of the filter 71 aims at preventing the bellows 30 from blocking the chamber 101. Otherwise, liquid 92 flow may be hindered.

While the invention herein disclosed has been described by means of specific embodiments, numerous modifications and variations could be made thereto by those skilled in the art without departing from the scope and spirit of the invention set forth in the claims.

What is claimed is:

1. A pressure container mounted in a water supplying system, comprising:
a container comprising a top chamber, an upper first space in fluid communication with the chamber, a lower second space separated from the first space and including a first port, a liquid intake through the first space, and a cover releasably secured to the chamber and including a second port in fluid communication with the chamber;
an air pipe assembly disposed externally of the container and comprising an air duct having one end connected to the second port and the other end connected to the first port, and an air input and air pressure regulator; and
a bellows releasably secured to the cover and disposed in the first space; wherein
in a first operation air is adapted to flow from the second space to the bellows through the first port, the air duct, the second port, and the chamber for expanding the bellows when air in the second space has a pressure larger than that of air in the first space;
in a second operation liquid is adapted to flow from the liquid intake into the first space to compress the bellows for expelling air into the second space via the chamber, the second port, the air duct, and the first port; and
in a third operation the bellows is pressed down by air flowing from the second space to the bellows through the first port, the air duct, the second port, and the chamber for flowing water out of the first space via the liquid intake.

2. The pressure container of claim 1, further comprising a filter mounted between the chamber and the bellows.
